(19) United States
(12) Patent Application Publication
(10) Pub. No.: US 2007/0218751 A1
(43) Pub. Date: Sep. 20, 2007

(54) MOUNTING SYSTEM FOR LIGHT TILES ATTACHED TO TENSIONED CABLES

(75) Inventor: Matthew Ward, San Francisco, CA (US)

Correspondence Address: FLIESLER MEYER LLP, 650 CALIFORNIA STREET, 14TH FLOOR, SAN FRANCISCO, CA, 94108, US

(73) Assignee: ELEMENT LABS, INC., Austin, TX (US)

(21) Appl. No.: 11/734,657

(22) Filed: Apr. 12, 2007

Related U.S. Application Data
(63) Continuation-in-part of application No. 11/076,273, filed on Mar. 9, 2005.
(60) Provisional application No. 60/552,965, filed on Mar. 11, 2004.
(60) Provisional application No. 60/831,907, filed on Jul. 18, 2006.
(60) Provisional application No. 60/884,856, filed on Jan. 12, 2007.

(51) Int. Cl. H01R 4/24

(52) U.S. Cl. 439/404

(57) ABSTRACT

Panels can be supported by cables formed out of cable segments. The cable segments can include a connector end and a latch end.

This application is a continuation-in-part (CIP) of the U.S. Non-Provisional patent application No. 11/076,273; entitled “SYSTEM FOR CREATING A TENSIONED WALL COMPOSED OF INDIVIDUAL LED TILES” filed Mar. 9, 2005 which in turn claims the benefit of U.S. Provisional Patent Application No. 60/552,965, filed Mar. 11, 2004.

This application also claims the benefit of U.S. Provisional Patent Application No. 60/831,907, filed Jul. 18, 2006 and U.S. Provisional Patent Application No. 60/884,856, filed Jan. 12, 2007.

### FIELD OF INVENTION

The present invention relates to lamps, especially lamps which contain light emitting diodes.

### BACKGROUND

Existing light tile systems typically require an extruded aluminum housing that must be attached to a metal frame of some sort. These frames are ground supported by an external structure or make use of rigging systems so they may be suspended from a rated point.

There are some LED tile systems that are transparent but that require frames and ground support structures. The systems require secondary support structures in order to create walls of significant size. This is an additional cost and the structure tends to work against the goal of creating a transparent wall system. Many of these systems are tied to the window size of the building as designed. These are custom systems using extremely large light guides which limit the amount of information that can be communicated.

Alternative direct view LED systems are available in tubes and modules but these systems are not intended to provide the fill level (the percentage of the area of a pixel which generates the image) that a tile system can provide. These systems do allow some level of transparency through variable pixel spacing or use in slat system. Examples of such systems are the Barco MiPix, the Opto Tech Intelligent Cluster, Lumino and the GLEC system.

Although some of these systems can be effectively integrated into the structure of the building they do not themselves constitute a wall or a structure. Any system must account for long term service since an installation may stand for decades. LED systems embedded in glass are an expensive problem.

### BRIEF SUMMARY

The system of one embodiment allows for the creation of a transparent tile wall supported by support wire, such as a tensioned aircraft cable. The system only requires access from one side for the installation and removal of tiles.

The light tiles can contain light guides which can receive the light from light source, such as LEDs, and redirect the light toward viewing positions. The light guide can spread the apparent source of the light.

### BRIEF DESCRIPTION OF THE DRAWINGS

FIG. 1A is a diagram of one embodiment illustrating basic tile configuration.

FIG. 1B is a diagram that shows a cable segment of one embodiment of the present invention.

FIG. 1C is a diagram that illustrates the connection of cable segments and panels in one embodiment.

FIG. 2 is a diagram illustrating the detail of a light tile of one embodiment.

FIG. 3 is a diagram illustrating the detail of a latch of one embodiment.

FIG. 4 is a diagram illustrating the detail of a hook of one embodiment.

FIG. 5 is a diagram illustrating the detail of a support cable of one embodiment.

FIG. 6 is a diagram illustrating additional detail of a latch of one embodiment.

FIGS. 7 and 8 are diagrams illustrating multi pixel light tiles of one embodiment.

FIG. 9 is a diagram illustrating a further tile layout with a yet further embodiment of the invention.

### DETAILED DESCRIPTION

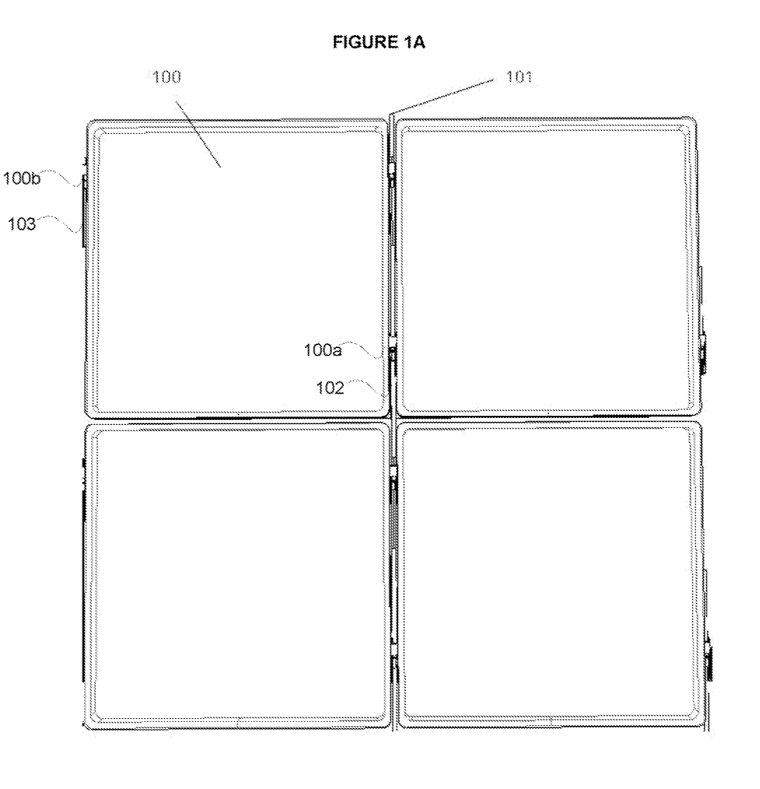

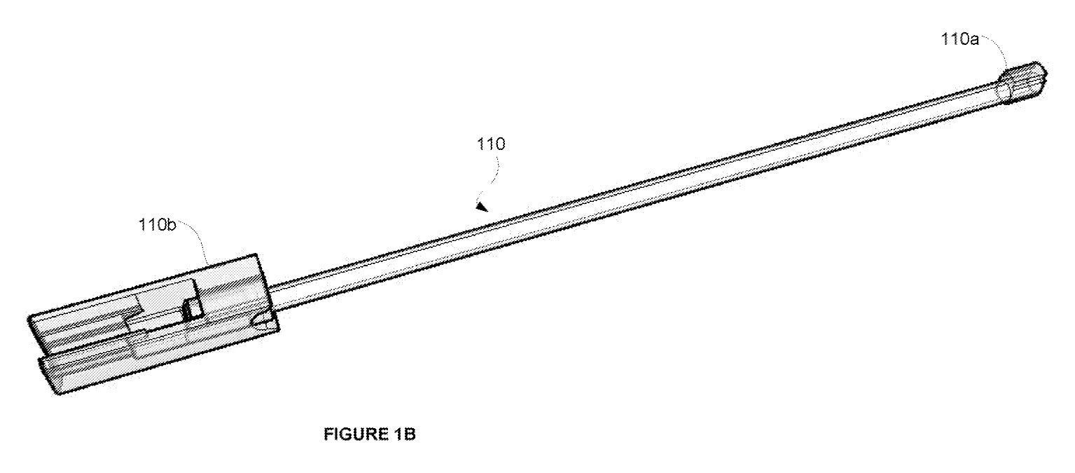

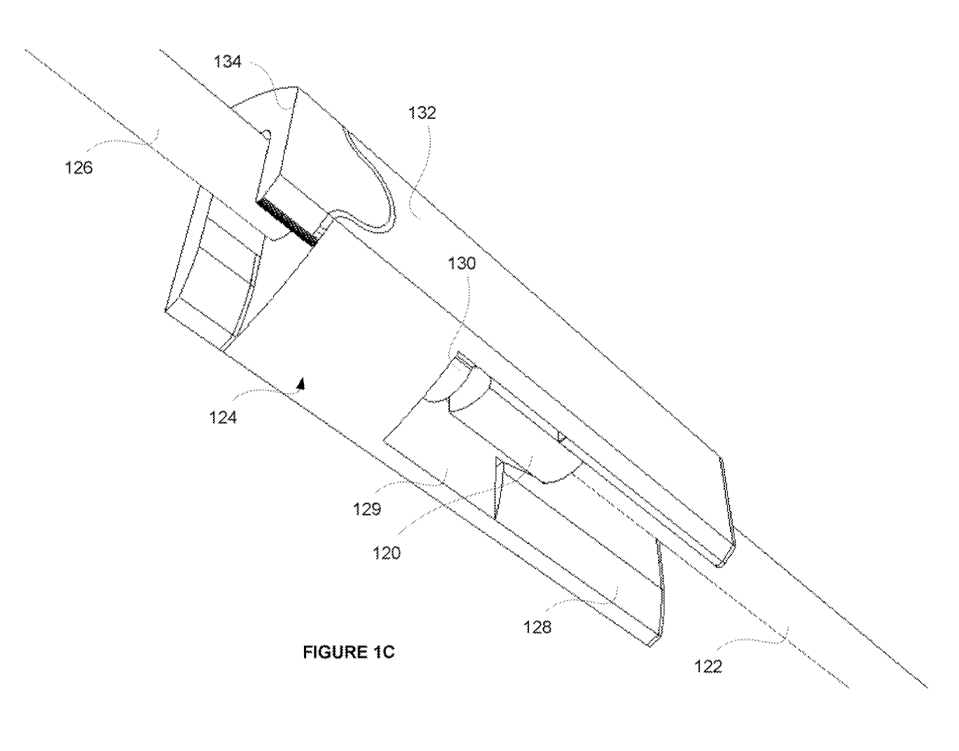

FIGS. 1A-1C illustrate an example of a system using panels and cable segments. FIG. 1A shows an example where an assembly comprises panel 100 with connection regions 100a and 100b connected to cable segments 102 and 103. FIG. 1B shows an exemplary cable segment 110. FIG. 1C shows the connection of the latch end of one cable segment to a connector end of another cable segment.

One embodiment of the present invention is a system comprising cable segments, such as cable segment 110, including a connector end 110a and a latch end 110b. The connector end of one cable segment is connectable to the latch end of another cable segment. Panels can connect to the latch ends of the cable segments. The cable segments can connect to form cables 101 and the panels 100 hang from the latch ends on the cable segments.

The panels can be lamps such as light tiles. The panels can form a display driven by a video signal. The panels can include LEDs and a light guide.The panels can alternately be non-light elements, such as windows or opaque panels.

The latch end can include a release 128 to disconnect a panel from the latch. The connector end 120 of one cable segment can fit inside a groove 129 in the latch end 124 of another cable segment 126 and can be held in place by a spring driven pin 130 on the latch end 124 of the another cable segment 126.

The cable segments can be made of metal or another material. The panels can connect to latch ends of cable segments on two sides.

The panels and cable segments can form a wall. A panel can be removed from the wall without removing any adjacent panels since the panels can rest on, but not interfere with the cable segment.

One embodiment of the present invention is a cable segment 110 including a connector end 110a and a latch end 11Ob. The connector end 110a of the cable segment 110c is connectable to a latch end of another cable segment. The latch end can contain a portion 110c for connecting to a panel.

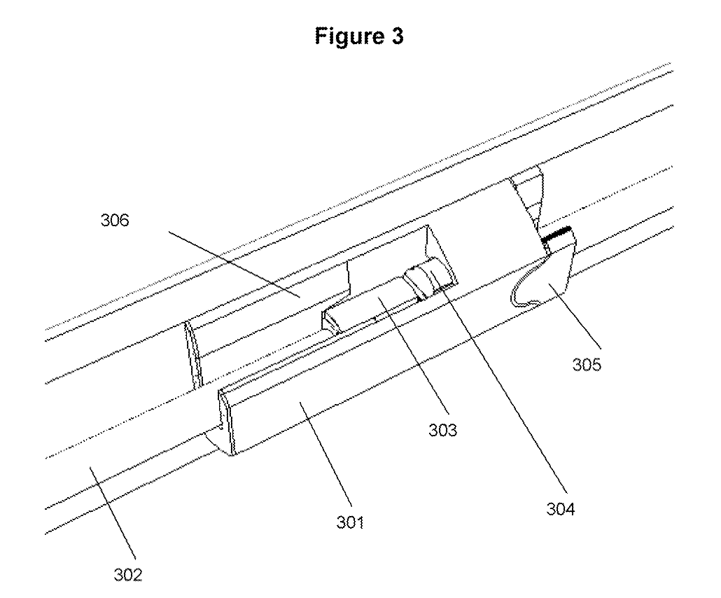

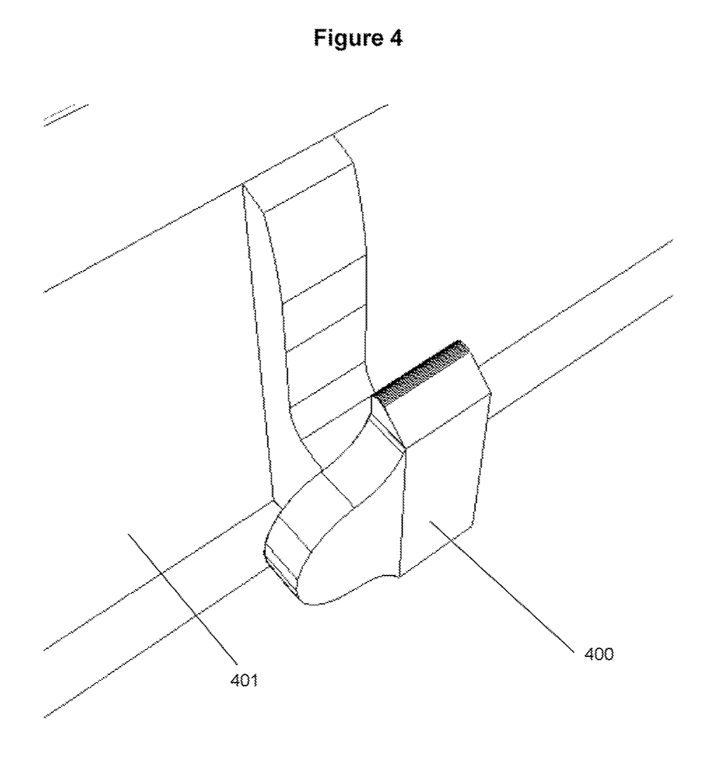

FIG. 1C shows a section 132 on latch end 124 connect to a portion 134 of a panel. A view of the portion of the panel of one embodiment is also shown in FIGS. 3 and 4.

One embodiment of the present invention is an assembly comprising a panel with sections on both sides for connecting to cable segments. Cable segments can be connected to the sections on both sides of the panel. The cable segments can include a latch end connected to the panel and a connector end. The latch end of the cable segments can be connectable to connector ends of other cable segments of other assemblies. These assemblies can be connected together to form a wall.

In one embodiment, the panels 100 are light tiles. Light tiles can be attached to and supported by the support wires 101. The light tiles can include a light source and a light guide. The support wires 101 may be tensioned to a degree that will allow the attachment of the light tiles. The support wires 101 can be formed of multiple cable segments.

The use of support wires can greatly reduce the weight of the entire structure. One problem with using a frame to hold up the light tiles is that this can greatly increase the weight of the entire system. Additionally, the use of support wires increases the total display area and visibility of the light produced by the light tile. The support wires can be spaced parallel to one another such as the light tiles can be attached in a regular pattern to the supports wires. The light tiles can include an attachment unit, or the attachment unit can be part of the support wires. In one embodiment, the light tiles are clipped to the support wires. In one embodiment, the light tiles can attach to two support wires. This can be done by using an attachment unit on two different sides of the light tile. The light tiles can be made waterproof, such that condensation does not form within the light tiles. The arrangement of the support wires can determine the shape of the system including the light tiles. For example, the support wires can be arranged in a helix, such that the light tiles form a column. The support wires can be angled or arranged to form a shape or curve. The light tiles can then be clipped to the unit.

FIG. 1A shows rectangular or square shaped light tiles, but the light tiles can be curved, hexagon, triangle or any other shape. Hexagon shaped light tiles have advantages in producing curved light displays. The connectors for the hexagon could be positioned on the back of the light tile, so that the light tile in adjacent columns can be attached to the same support wire.

Data and power can be distributed using a series of nonstructural utility bars or backup structures. A secondary structure can be positioned in behind or in front of the curtain wall (or in front depending on your point of view) Main power distribution and the addressing of the tiles can be handled by electronics concealed in these structures. The bars can be spaced meters apart which also adds to the overall transparency of the system.

Power and data can be looped from tile to tile with connectors in a serial data system. Alternately, a column and row drive system could be used to minimize the amount of data distribution. Such a system might incorporate the support wires. Column information can be sent over the support wires (perhaps encoded with the power) and the row information can be looped from tile to tile.

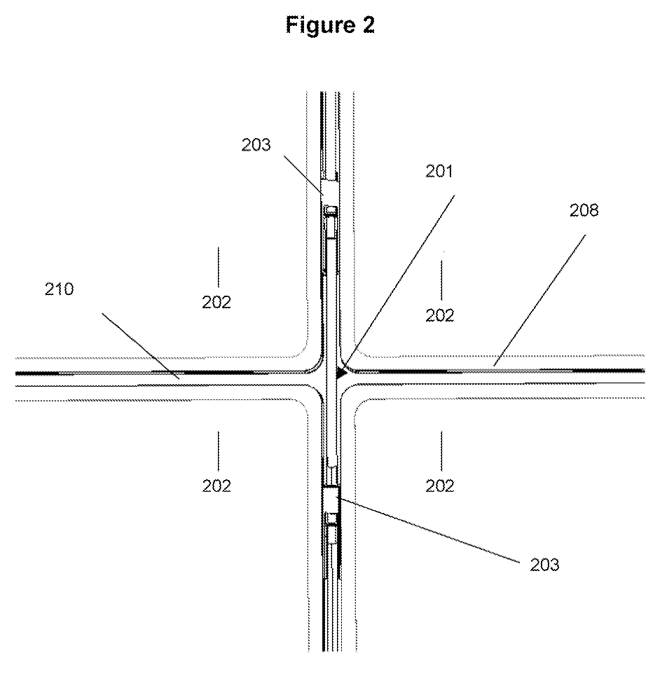

FIG. 2 shows a detail of an embodiment. The support wire 201 is tensioned between light tiles 202. Each light tile 202 can be connected to the tensioned support wire 201 using a two part latch 203. The “two part” refers to the fact that a first and second task must be performed to disconnect the latch 203 before the light tile 202 is loose and able to be removed. Alternately, the latch can be a “single part” latch.

In a further embodiment, at least one edge of the light tile 202 is composed of an engineered aluminum extrusion 208. The gap 210 between the light tiles 202 may be filled with a silicone caulk or clear rubber tubing after installation. This allows for thermal expansion and contraction of the large array and will accommodate slight movement between light tiles 202.

FIG. 3 shows the detail of a latch of one embodiment. The latch 301 is attached to a support wire 302 which has a cable connector end 303 which may be swaged. The swaged end connector 303 can fit into a slot on the latch 301 and can be retained in this slot by pressure from a pin 304. The pressure on pin 304 can come from an associated spring which sits in a cavity in the top of the latch 301 behind the pin 304. This latch end 301 can either be left as part of the support wire 301 when a light tile is removed for service or be attached to the light tile for easy installation.

A secondary attachment may be made through a hook 305 which is permanently a part of the panel attached to the light tile. The hook 305 may be attached to the latch by a removable pin (not shown).

In one embodiment to detach the support wire 302 from the latch end 301 it is necessary to first slide back the pin 304 against its spring pressure and then to press release button 306. The support wire 302 may then be lifted out from the latch 301 thus releasing the light tile from the support wire 302.

FIG. 4 shows the detail of a hook 400 of one embodiment. The secondary attachment hook 400 can be attached to an aluminum extrusion 401 that forms the core of the light tile.

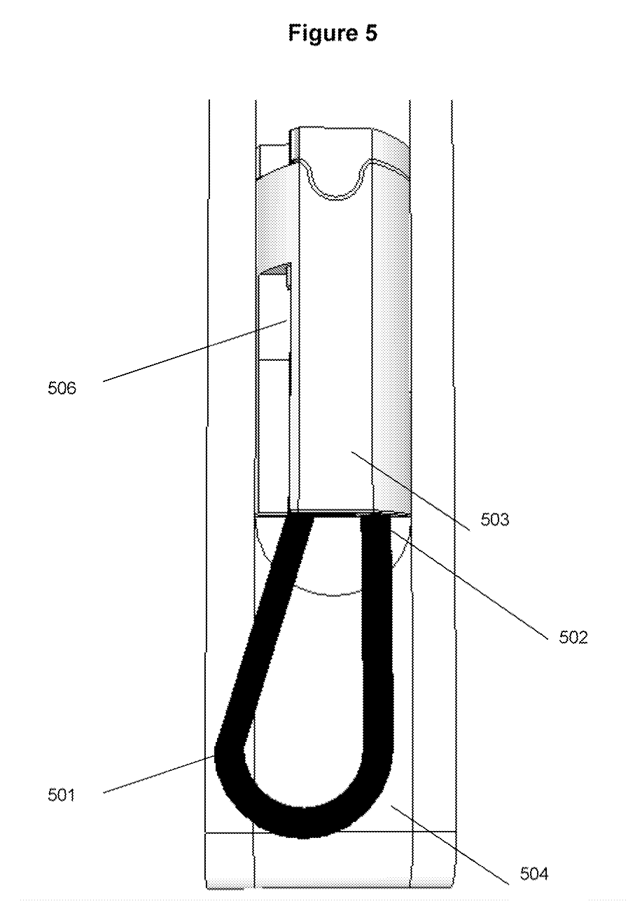

FIG. 5 shows the detail of a support cable of one embodiment. The support cable 502 may extend out of the latch 503 which is attached to the aluminum extrusion 504 that forms the core of the light tile. The support cable 502 on the last light tile in a run may be looped up 501 and the swaged metal end connector 506 locked into the latch 503 for cable management.

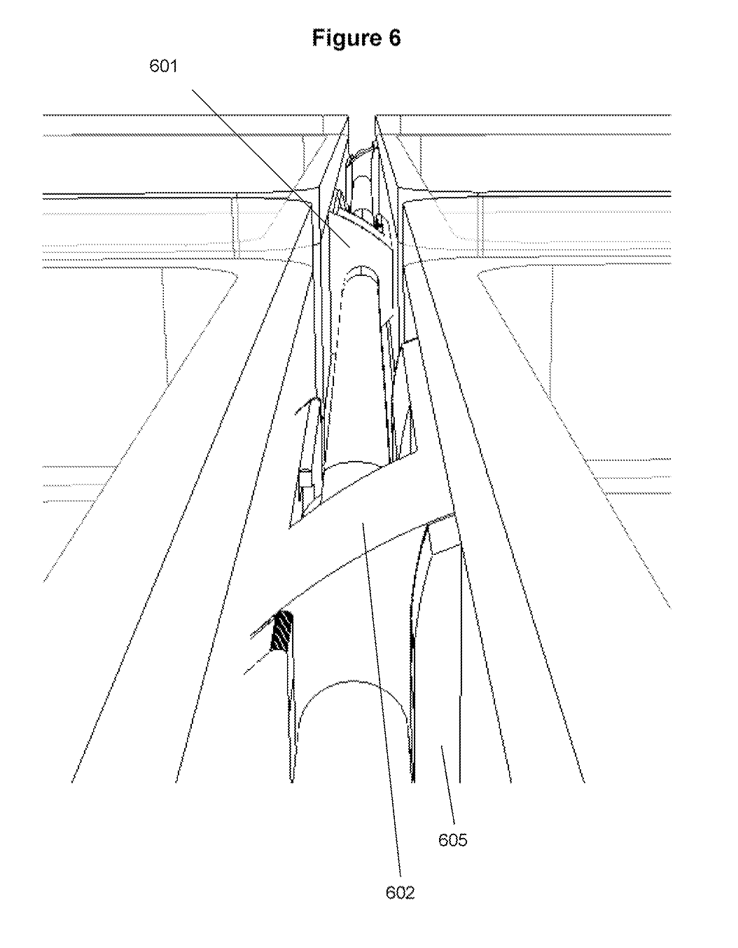

FIG. 6 shows additional detail of the latches of one embodiment. In an assembly with more than one light tile the latches 601 and 602 alternate so that a latch 602 at the bottom right side of one light tile attaches by support cable to a latch 601 on the top left side of the next light tile.

The hook 605 may be mounted to the light tile in the adjacent row or column and can be used to lock one row or column of light tiles to the adjacent row or column of light tiles.

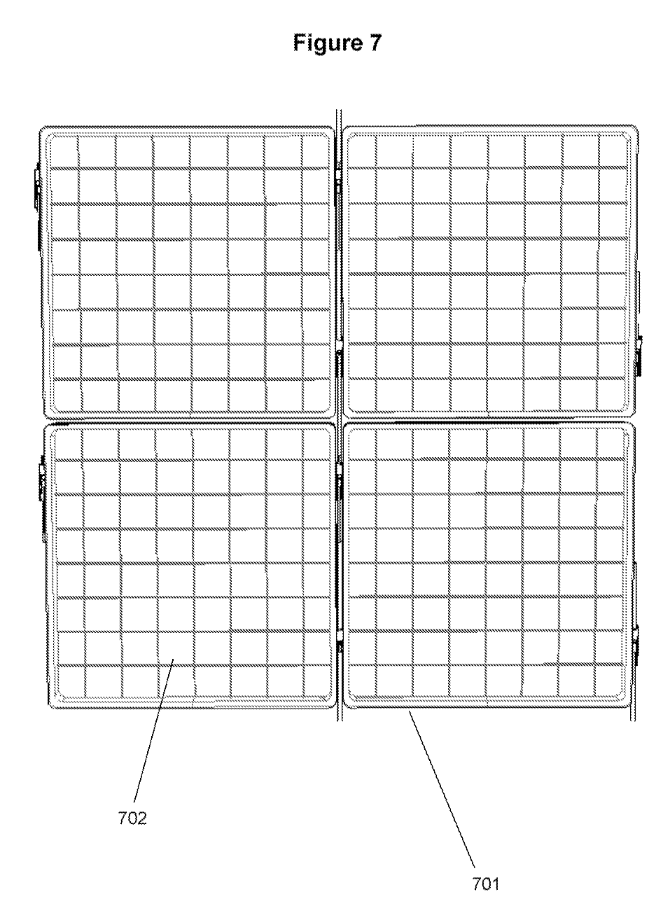

FIG. 7 shows a further embodiment where the light tiles 701 each comprise multiple pixels 702.

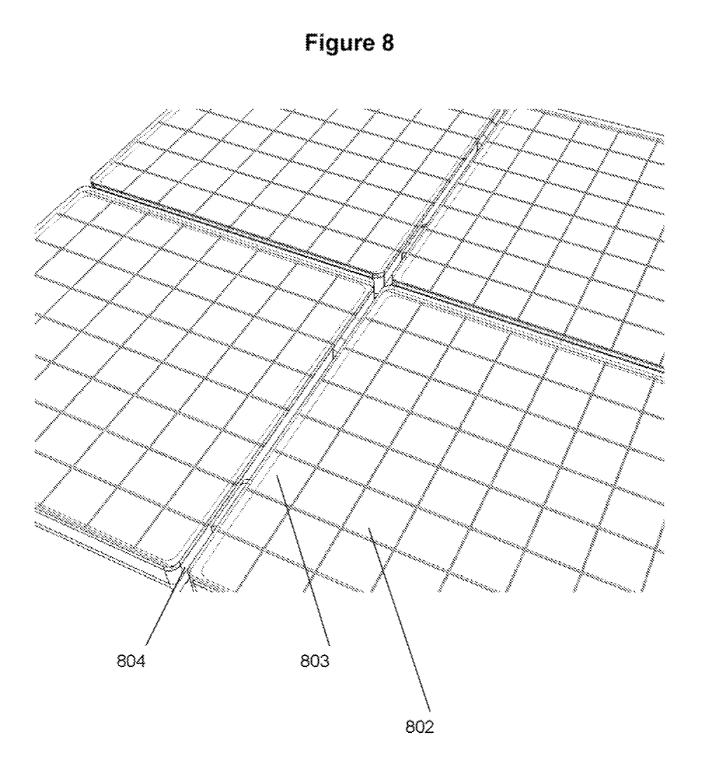

FIG. 8 shows that light tiles 802 may be configured in such a way that the pixels 803 on the sides of the light tiles 802 are adjusted in size to compensate for the channel 804 required for the cable and thus maintain an equal pixel spacing over the whole display.

The light tiles 802 can include different colored LEDs. The light tiles can produce light by mixing light of the different colored LEDs. The light tiles can include a light guide to spread the light over a larger area. The system may also include a control unit adapted to use a video signal to control colors of the light tiles. The light source can provide light of different colors.

The front or back of the light tiles can be translucent. The attachment mechanism can be part of the cable system. The tile can use a light source other than LED such as OLED, PLED or even more traditional lamps such as fluorescent.

The tile can be square, rectangular or any other shape that might be easily integrated into a large array of tiles so that the tiles both fit together and can be suspended from a tensioned cable system.

Patterns can be incorporated in the molding of the shell or the pattern of the light guide or printed dot pattern on the light guides. The pattern on the light guide can be injection molded. Interesting shapes can be created by tensioning cable to different locations within a single installation. For example a helix shape can be produced.

Photovoltaic's can be included along with a power storage component of some sort in order to make the system self-sufficient on power should conditions allow.

Tile can be made in curved forms. Multiple tiles can be fabricated together in panels and then attached to a tensioned system thereby reducing the number of attachment points. The cable size and point load considerations may outweigh this benefit.

Materials other than steel can be used for the tensioning lines. Composite materials and more traditional rigging materials such as webbing are possibilities. In smaller systems metal flat stock could be used as the supporting component even though it is not tensioned.

Power distribution can be incorporated into the tensioning cables.

Tiles using the Planon, or other flat fluorescent light source, can be incorporated into the tile system in order to provide light in certain locations.

The power and data can be distributed from the side with a vertical utility column rather than from the bottom using a horizontal utility column.

The system described here can easily be integrated completely into a standard glass curtain wall system by a company such as Pilkington. This completely eliminates and additional structure that might be required for such a system in turn reducing the cost of the project. A system using the light guide with the dot pattern would also partially reflect light back away from a building helping to reduce the heat load.

The light tiles can display information from a video signal. In one example, the light tiles can mix light from clusters of red, green and blue LEDs. A light guide can help mix the light from the LEDs. The light guide can spread the perceived origin of the light over a wider area as well as redirect the light to viewer locations.

Control units can receive a video signal over a video data bus from a video processor. Any type of video signal can be used. The control unit can select a sub-set of the pixels of the video data to drive the LEDs in the light tiles. The sub-set of pixels can be determined by addresses which are provided across the control bus or in another manner. In one example, the light tile group is an 8×8 grid of light tiles. An 8×8 sub-set of pixels within the video signal can be selected to determine color information for the light tiles. Data for more than one pixel in the video can be used to produce a single color to be displayed on a light tile within the light tile groups. The control unit can be used to adjust the intensity of the LEDs in accordance with a video signal. A monochrome embodiment can use LEDs of the same color to produce a single color, or “black-and-white” display.

In one embodiment, the color information from the video signal is converted to driving voltages for the LEDs. The LEDs are preferably calibrated so that the same driving voltage produces similar color intensities for the different colored LEDs.

A personal computer with local monitor can control a signal processor. The signal processor can provide a video signal to multiple panels. Each panel is constructed of multiple light tiles

Picture element light tiles can use a light guide to mix colors and spread the light so that the apparent source of light is a relatively wide region such as, the front facing surface of the light tiles. This makes it comfortable to view the light tile from a few feet away. The low resolution picture element light tiles are thus very useful for designers and architects to incorporate into video displays in retail environments.

In one embodiment, the pitch, the distance from the center of one pixel to the center of the next pixel, is no less than 20 millimeters. In a further embodiment, the pitch is 40 mm or greater.

In a yet further embodiment, the pixel size of the light tile is about 20 mm or greater in width. Since the light tiles are relatively large, the disadvantages of prior art systems are avoided. Such pixel element light tiles are significantly larger than those normally used in video displays. Video displays focus on making the pixels as small as possible and the use of larger pixels is counter-intuitive.

The use of the pixel wall element also addresses a number of criteria, in addition to viewing distance, which influence decisions regarding the use of low resolution video displays. Depth is a critical issue in any design process given the cost of floor space in any building. The wall mounted, picture element can be made relatively thin. The low resolution video display can be adapted to work with a wide variety of design specifications while maintaining a low price point. The low resolution video display can be easily integrated with other interior requirements such as shelving and signage.

In a further embodiment, each pixel is packaged as a self-contained light tile for ease of maintenance. A housing may conceal the LEDs.

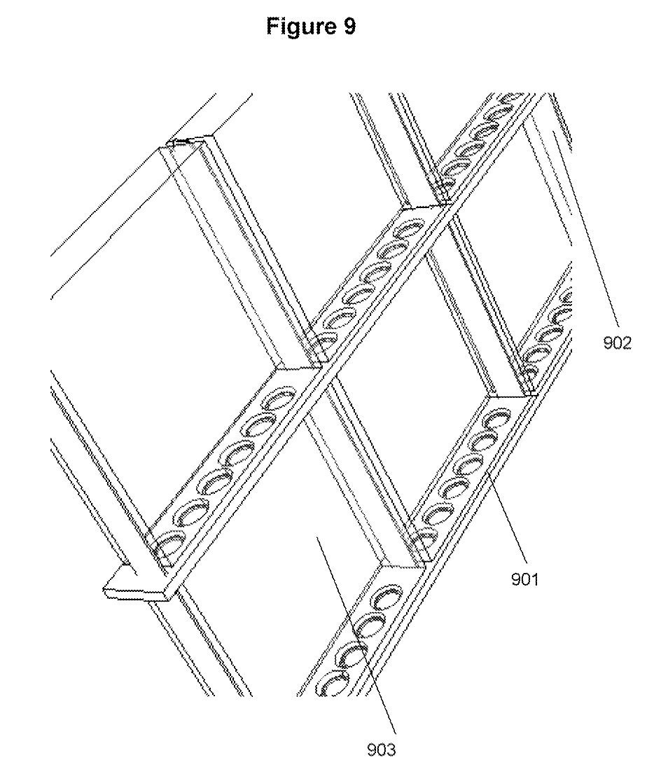

FIG. 9 shows a further tile design which may use a further embodiment of the invention.

The LEDs may be mounted on a printed circuit board (PCB) 901 in a strip at the base of the pixel. A cable assembly can connect from PCB to a control unit (driver board) which converts incoming video information into voltage for the LEDs. The data and power supply signals comprising this information can further be passed from one PCB 901 to a further PCB through the pins 902. Pins 902 have a thin cross-section to minimize their intrusion into the tile and thus maximize the transparency of the tile. Light from the LEDs is directed into a light guide 903. The light guide 903 can be constructed of a plastic, glass or other material. In one embodiment, the light guide 903 has a collimator to collimate light from the LEDs mouthed on the PCB 901. The light guide 903 can also use a printed pattern to reflect the light forward toward viewing positions. In one embodiment, the light guide uses diffusion, such as a Fresnel grating, on the front facing surface. The back and/or sides of the housing can be treated with or composed of a reflective material. Light from the light tile is directed forward toward an optional cover or shell. The cover or shell can be a diffusion plate and/or tinted to improve the contrast of the color. Such a tile is a lightweight construction and may be advantageously supported and suspended on a tensioned cable system as herein described.

Surface Mounted LEDs can be used. Surface Mounted LEDs are relatively expensive but allow for a more compact light tile. A separate mixing light guide may be used, with or without a reflector, in order to achieve a more complete homogenization of color. The LEDs may be mounted perpendicular to the light guide. Organic LEDs (OLEDs) may be used to create the light tiles. Though-hole LEDs can also be used. The light tiles may be removed from the support wires and used separately with the same power distribution and video driver. The pixel size is not fixed. Different sized pixel light tiles may be used in one system. A driver board may have an adjustment for cable length due to resistive losses in the cables. Different types of materials may be used as light guides. A screen can be fabricated without the tinted plastic front face if contrast is not a priority. Slugs or plastic covers with no electronics can be mixed in with functioning pixels in a grid. Textured front faces or other coverings may be attached or hung in front of the pixels. A coating may be used on the front face to improve contrast. LED clusters at both ends can be used to maximize light output and color mixing a light tile. The light tiles can be housed in a transparent plastic or glass sheet. The pixel light tiles can be used to edge light shelving or to backlight signage.

The materials for the light tile can be IP 66 or IP 68 approved materials to allow for the external use of the light tiles. In one embodiment, the LEDs are grouped on the PCB in clusters of red, green and blue LEDs. The LEDs can preferably be calibrated so that a conventional video driver for LEDs to produce light that can be mixed within the light guide with the light tiles of the present invention.

The picture element light tiles can use a video signal to provide dynamic lighting effects within a store or other location. The video signal can be a prestored signal from a storage medium, such as a DVD or computer memory. Alternately, the video signal can be from a camera or computer generated.

The light guides can be used to create large video displays in which each picture element can be viewed from 360 degrees vertical orientation and 160 degrees horizontal orientation. The pixel light tiles can be placed anywhere with no fixed distance between the light tile and the required video processing.

Existing screens have a fixed relationship in pitch which is a measurement of the distance from a pixel center to the next pixel center. A 10 mm screen fabricated using the Modular Enclosure method will always be a 10 mm screen. The design of the pixel light tile allows a designer to change pitch in a graduated manner within one screen while the screen is being installed.

The LED cluster may be Surface Mounted Device (SMD). In one embodiment, a basic cluster is composed of at least one red, green and blue LED mounted to a PCB. A cable assembly from the LED cluster to a driver board. The cable assembly may or may not be IP 68 rated for outdoor use. A light guide assembly can include a visible element such as a bulb and may also include a neck and/or a collimating lens (not pictured). The parts in this assembly can be selected based on the LEDs being used. Light guides can be composed of optical grade PMMA/Acrylic and other material. A layer of light-scattering diffusion on the outside of the bulb which can be applied as a coating or as a surface treatment. This may also include a UV coating and an anti-reflective coating.

A control unit, such as a driver board, can send line voltages down the cable assembly to the LED cluster. Light from the LED cluster is channeled into the light guide assembly. If it is required by the type of LED used, the light guide will initially be used to mix the colors of the individual red, green and blue LEDs. The light will next pass into the visible part of the light guide, such as the bulb, where it is reflected until it strikes the outside of the bulb can be treated to allow the light in the guide to escape. This makes the light guide glow.

Any number of such pixel light tiles may be used in a system. To maximize light output and color mixing a tube could be used with LED clusters at both ends. The light guides can be irregular shapes and heights to create a video topography. Surface Mounted LEDs may require no mixing light guide and a significantly smaller bulb portion. A high intensity white (or other color) LED can shine down from the middle to light space below while the video pixel makes the light tile glow. This in essence becomes a pixel within a pixel.

A coating may be used to improve contrast. Alternate materials may be used for the light guide such as polycarbonate. Any number of LED's may be used as well as different combinations of colors. Applications for a bulb based pixel light tiles include a video ceiling, a video dividing wall, a video curtain for a performance in the round and a window decoration in an atrium. The screen can also be used in conjunction with a number of hard and soft translucent coverings.

One embodiment of the present invention uses a group of relatively large pixel light tiles. In one embodiment, at least some of the light tiles being greater than or equal to 20 mm in pixel size. At least one LED can be used to produce light of different colors. A control unit is adapted to set the color of the light tiles in accordance with a video signal.

The light tiles can be constructed using a light guide as described above. The light guide can spread the light over a wider area. Light from different colored LEDs is mixed in the light guide

Alternately, an embodiment without a light guide can be used. Large-sized LEDs can be used. In one embodiment, groups of LEDs or clusters of LEDs driven with the same signal can be used. The LED(s), LED groups or LED clusters can be positioned on the outside of the light tile. In this way a pixel size of greater than 20mm can be created.

Organic LEDS (OLEDs) and polymer LEDs (PLEDs) can be used. OLEDs and PLEDs are especially useful for the embodiment without a light guide.

In addition to retail environments, the embodiments of the present invention are useful for many other applications including concert touring, TV production, other architectural environments, clubs, theme parks, corporate events, etc. In one embodiment users can use the light tiles to form scenic elements.

There are many uses for the light tiles in furniture for use as table tops, Chinese/Japanese folding screens, counter tops, headboard for beds, and shelving. The light tiles can be a substitute for traditional ceramic/mosaic tiles for example in showers, etc.

The light tiles can be used as floor panels and ceiling tiles. The light tiles can cover the outside of a building or be used to produce doors. The light guide can be curved or an irregular shape (octagon, mosaic tile, etc). The light guide can be an entire object: such as a chair, table top.

The frames used can be constructed of a flexible material, such as rubber. This can allow the frames to be connected to a curved wall for example. The frames can be hinged

The light tiles can be light from the edge to allow the light tiles to be placed with little or no gap between the tiles. The tiles can have beveled edges allowing the LEDs to shine in at an angle from behind. Mirrors, prisms, or other optical devices can be used to reflect the light. This may make the system slightly deeper, but it can eliminate/minimize the frame around each pixel

In one embodiment, the light guide is mostly transparent when the LEDs are turned off and suitable for use as a window. When turned on, the light guide glows with color.

In one embodiment, a large diffuser which covers multiple light tiles is positioned in front of the light tiles to make a seamless image. The diffuser can be positioned some distance from the light tiles.

In one embodiment, the circuit board and a light guide are placed in a metal frame and no assembly holds the two together before placing them in the frame. The frame and the light guides can be a single piece of molded acrylic or polycarbonate. The circuit boards containing the LEDs can be slotted in place in this block.

In one embodiment, the light guide can include active and non-active areas. The non-active area will not glow as significantly as the active area. An active area of the light guide can be a distance from the LED source in a larger sheet of acrylic instead of starting right by the LED sources

A light guide can have variable density of reflecting material. One use of a variable density of reflecting material is to help maintain an even light output as light intensity falls off from the source. A gradient pattern can keep the apparent intensity constant.

In one embodiment, a wall can be made of vertical rods where the light guides radiate from the rods in a fixed or variable manner. The rods themselves can also move. In one embodiment, a light tile is a laminated piece of plastic/glass where the LEDs and the light guides are contained in a sandwich. All of the elements can be transparent.

Silk screening can be used to create different shapes and patterns on the light tiles. Reflective materials behind the light guide can be used to show different images when the light is off

The light tiles can be a single or dual color version. A single color version can effectively produces a black-and-white display. Information for a single or dual color version can be derived from a video signal.

The light tiles can be wirelessly connected to control elements using a wireless connection such as WiFi, Bluetooth, etc.

The light tiles can be linked to a trigger, such as a doorbell. The light tiles can use music to set the light functionality. For example, an audio signal can be used to produce a video signal that drives the light tiles. The light tiles can be linked to a clock to shine different colors at different times in the day. The light tiles can have a touch sensitive surface that activates the lights. Interactive feedback can be used to trigger the lights from sensors to detect, weight, sound, heat/motion, and/or ambient light levels.

In one embodiment a video output on the last light tile in a sequence is used to help verify remotely that the system is working.

In one embodiment, a laminated panel is used where the LEDs and the light guides are contained within a sandwich of transparent panels. The transparent panels could be acrylic, polycarbonate of glass or any other optically appropriate material.

In one embodiment, dichroic or other red, green and blue filters are used with white LED light sources to create a source of illumination for the light guide.

The foregoing description of preferred embodiments of the present invention has been provided for the purposes of illustration and description; it is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. A system comprising:
cable segments including a connector end and a latch end, wherein the connector end of one cable segment is connectable to the latch end of another cable segment; and
panels that connect to the latch ends of the cable segments, wherein cable segments connect to form cables and the panels hang from the latch ends on the cable segments.

2. The system of claim 1, wherein the panels are lamps.

3. The system of claim 1, wherein the panels form a display driven by a video signal.

4. The system of claim 1, wherein the panels include LEDs and a light guide.

5. The system of claim 1, wherein the panels are windows.

6. The system of claim 1, wherein the latch includes release to disconnect the panel from the latch.

7. The system of claim 1, wherein the connector end of one cable segment fits inside a groove in the latch end of another cable segment and is held in place by a spring driven pin on the latch end of the another cable segment.

8. The system of claim 1, wherein the panels connect to latch ends of cable segments on two sides

9. The system of claim 1, wherein the panels and cable segments form a wall.

10. The system of claim 9, wherein a panel can be removed from the wall without removing any adjacent panels.

11. A cable segment including a connector end and a latch end; wherein the connector end of the cable segment is connectable to a latch end of another cable segment and wherein the latch end contains a portion for connecting to a panel.

12. The cable segment of claim 11, wherein the portion for connecting to a panel is shaped to fit a section of the panel.

13. The system of claim 11, wherein the panels form a display driven by a video signal.

14. The system of claim 11, wherein the panels include LEDs and a light source.

15. The system of claim 11, wherein the latch end includes release to disconnect the panel from the latch end.

16. The system of claim 11, wherein the connector end of one cable segment fits inside a groove in the latch end of another cable segment and is held in place by a spring driven pin on the latch end of the another cable segment.

17. An assembly comprising:
a panel with sections on both sides for connecting to cable segments; and
cable segments connected to the sections on both sides of the panel, the cable segments including a latch end connected to the panel and a connector end, the latch end of the cable segments being connectable to connector ends of other cable segments of other assemblies.

18. The assembly of claim 17 further comprises additional assemblies to form a wall.

19. The system of claim 17, wherein a panel can be removed from the wall without removing any adjacent panels.

20. The system of claim 17, wherein the panels are lamps.

21. The system of claim 17, wherein the panels form a display drawn by a video signal.

22. The system of claim 17, wherein the panels include LEDs and a light guide.

23. The system of claim 17, wherein the panels are windows.

24. The system of claim 17, wherein the latch end includes release to disconnect the panel from the latch end.

25. The system of claim 17, wherein the connector end of one cable segment fits inside a groove in the latch end of another cable segment and is held in place by a spring driven pin on the latch end of the another cable segment.
